(19) United States
(12) Patent Application Publication
(10) Pub. No.: US 2026/0011046 A1
(43) Pub. Date: Jan. 8, 2026

(54) DISPLAY METHOD, DISPLAY PROCESSING DEVICE, AND NON-TRANSITORY COMPUTER-READABLE STORAGE MEDIUM STORING DISPLAY PROCESSING PROGRAM

(71) Applicant: Yamaha Corporation, Hamamatsu (JP)

(72) Inventor: Satoshi UKAI, Hamamatsu (JP)

(21) Appl. No.: 19/327,957

(22) Filed: Sep. 12, 2025

Related U.S. Application Data
(63) Continuation of application No. PCT/JP2024/008032, filed on Mar. 4, 2024.

(30) Foreign Application Priority Data
Mar. 15, 2023 (JP) 2023-040546

(51) Int. Cl. G06T 11/00; G06F 3/16; G06V 20/40; G06V 20/52; G06V 40/10

(52) U.S. Cl. CPC G06T 11/00; G06V 20/44; G06V 20/52; G06V 40/10; G06F 3/167

(57) ABSTRACT

A display method includes receiving a camera image, receiving area information indicating a use area of an event, and superimposing, on the camera image, a boundary image on a horizontal plane and displaying the boundary image superposed on the camera image, and the boundary image corresponds to the area information.

### CROSS-REFERENCE TO RELATED APPLICATIONS

This application is a continuation application of International Application No. PCT/JP2024/008032, filed on Mar. 4, 2024, which claims priority to Japanese Patent Application No. 2023-040546 filed in Japan on Mar. 15, 2023. The entire disclosures of International Application No. PCT/JP2024/008032 and Japanese Patent Application No. 2023-040546 are hereby incorporated herein by reference.

### BACKGROUND

### Technical Field

This disclosure generally relates to a display method, a display processing device, and a non-transitory computer-readable storage medium storing display processing program.

### Background Technology

Japanese Laid-Open Patent Application No. 2006-126424 discloses a car audio system that displays an icon on a display device indicating a speaker position, thereby visualizing the speaker's position.

Japanese Laid-Open Patent Publication No. 2006-201286 discloses an in-vehicle sound collection device that: collects voice of a speaker inside a vehicle with microphones 17A and 17B; reads, from data memory 14, image data representing input sound pressure level and image data representing directionality of the two microphones 17A and 17B; and generates, and displays on a display 15, display data obtained by rasterizing the image data.

### SUMMARY

The prior art is not for displaying a range of use.

An object of one aspect of the present disclosure is to provide a display method by which it is possible to easily understand the range of use of an event in a given space.

The display method comprises receiving a camera image; receiving area information indicating a use area of an event, and superimposing, on the camera image, a boundary image and displaying the boundary image superposed on the camera image. The boundary image corresponds to the area information.

### BRIEF DESCRIPTION OF THE DRAWINGS

FIG. 1 is a block diagram showing a configuration of a display processing device 1.

FIG. 2 is an example of a video displayed on a display unit 5 as an OSD according to the display method of the present embodiment.

FIG. 3 is a flowchart showing an operation of the display method.

FIG. 4 is an example of a video displayed on the display unit 5 as an OSD according to the display method of the present embodiment.

FIG. 5 is an example of a video displayed on the display unit 5 as an OSD according to the display method of the present embodiment.

FIG. 6 is an example of a video displayed on the display unit 5 according to a First Modified Example.

FIG. 7 is an example of a video displayed on the display unit 5 according to a Second Modified Example.

FIG. 8 is an example of a video displayed on the display unit 5 according to a Third Modified Example.

FIG. 9 is an example of a video displayed on the display unit 5 according to a Fourth Modified Example.

FIG. 10 is an example of a video displayed on the display unit 5 according to a Fifth Modified Example.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

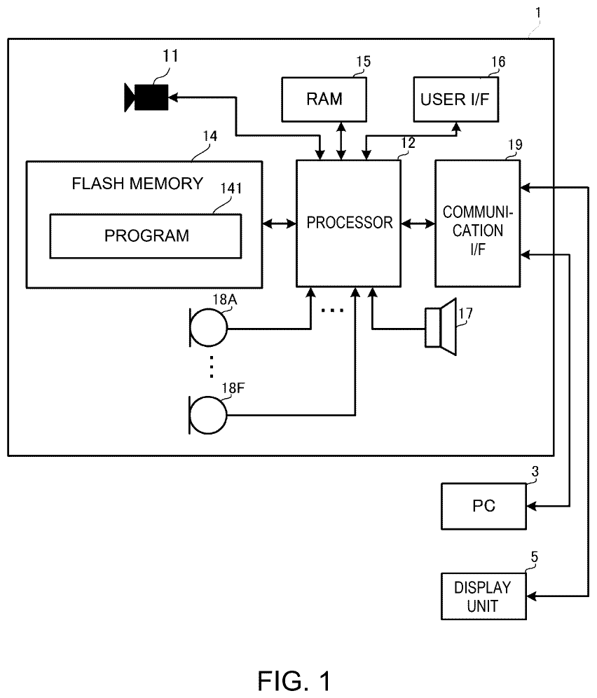

FIG. 1 is a block diagram showing a configuration of a display processing device 1. The display processing device 1 is connected to a personal computer (PC) 3 and a display unit 5. The display processing device 1 and the PC 3 are connected via a cable such as a USB (Universal Serial Bus) cable, for example. The display processing device 1 and the display unit 5 are connected via a cable such as an HDMI (registered trademark) cable, for example.

The PC 3 is a general-purpose information processing device that executes, for example, a remote conference application program that sends and receives video signals and sound signals. In the present embodiment, a signal means a digital signal.

The display unit 5 is a display device (display) such as an LCD (Liquid Crystal Display) or an OLED (Organic Light-Emitting Diode). The display unit 5 displays a video relating to the above-mentioned remote conference application program executed on the PC 3.

The display processing device 1 comprises a camera 11, a processor 12, flash memory 14, RAM 15, a user interface (I/F) 16, a speaker 17, six microphones 18A-18F, and a communication interface (I/F) 19.

The camera 11, the speaker 17, and the microphones 18A-18F are arranged above or below the display unit 5, for example. The camera 11 acquires a camera image obtained by imaging users in front of the display unit 5. The microphones 18A-18F acquire voices of the users in front of the display unit 5. The speaker 17 outputs sound to the users in front of the display unit 5. The number of microphones is not limited to six. The number of microphones can be one. The number of microphones in the present embodiment is six, which constitute a microphone array. The processor 12 executes beamforming processing on sound signals acquired with the microphones 18A-18F.

The processor 12 reads an operating program from the flash memory 14 into the RAM 15, thereby functioning as a control unit (electronic controller) that comprehensively controls the operations of the display processing device 1. For example, the flash memory 14 stores a program 141. The processor 12 executes the display method of this disclosure, using the program 141. It is not necessary for the program 141 to be stored in the flash memory 14 of the host device. The processor 12 can download the program 141 from a server, etc., as needed, and read the program 141 into the RAM 15. The processor 12 is a processor such as a CPU (Central Processing Unit). The processor 12 is one example included in the electronic controller of the display processing device 1, and the electronic controller can be configured to comprise one or more processors. Here, the term “electronic controller” as used herein refers to hardware, and does not include a human.

The program 141 according to this disclosure can be provided in a form stored in a computer-readable storage medium and installed on a computer. The storage medium is, for example, a non-transitory storage medium, which can be the flash memory 14 and an optical storage medium (optical disc) such as a CD-ROM, but can include storage media of any known form, such as a semiconductor storage medium or a magnetic storage medium. Non-transitory storage media include any storage medium that excludes transitory propagating signals and does not exclude volatile storage media.

The processor 12 receives a video signal from the PC 3 via a USB cable. The video signal is video relating to the above-mentioned remote conference application program. The processor 12 transfers the video signal that has been received to the display unit 5 via an HDMI (registered trademark) cable. In addition, the processor 12 superimposes a camera image acquired from the camera 11 onto the video relating to the above-mentioned remote conference application program, and displays the video on the display unit 5 as an on-screen display (OSD). The processor 12 outputs, to the PC 3 via the communication I/F 19, a video signal relating to the camera image acquired from the camera 11 The processor 12 executes beamforming processing on the sound signals acquired with the microphones 18A-18F, and outputs the sound signals after the beamforming processing to the communication I/F 19.

The processor 12 executes directionality processing such as beamforming processing to thereby apply a mask process so as not to collect sounds outside of the use area of the event. Examples of the beamforming include: a process of adding a delay-and-sum type sound collection beam output oriented toward each conference participant; a minimum variance processing that minimizes the overall power while applying certain constraints to the gain in the direction of each conference participant; a generalized sidelobe canceller (GSC) processing that uses the addition of the delay-and-sum type sound collection beam output directed toward the conference participants and the output of a block matrix (BM) that forms a null in the direction of the conference participants; a binary mask processing in which the power of the microphone device output is compared with the power of the delay-and-sum type sound collection beam outputs divided by frequency bands, the divided delay-and-sum type sound collection beam output is attenuated only when the divided delay-and-sum type sound collection beam output is smaller by a certain amount or more, and the divided delay-and-sum type sound collection beam outputs are reintegrated; and a process in which a sound source is separated from the collected sound signal by a sound source separation method such as independent component analysis (ICA), the direction of arrival of each separated sound source signal is determined by the projection back (PB) method, and only the sound source signal arriving from the direction of the conference participants is mixed.

The communication I/F 19 outputs a video signal and a sound signal to the PC 3. The remote conference application program on the PC 3 transmits, to other devices, the video and sound signals output from the communication I/F 19. In addition, the remote conference application program on the PC 3 receives video and sound signals from other devices. The PC 3 outputs, to the communication I/F 19, the video and sound signals that have been received.

The processor 12 transfers the video signal received from the communication I/F 19 to the display unit 5 via an HDMI (registered trademark) cable. In addition, the processor 12 outputs, to the speaker 17, the sound signal received from the communication I/F 19. The display processing device 1 thereby functions as a communication system for carrying out voice conversations with remote locations.

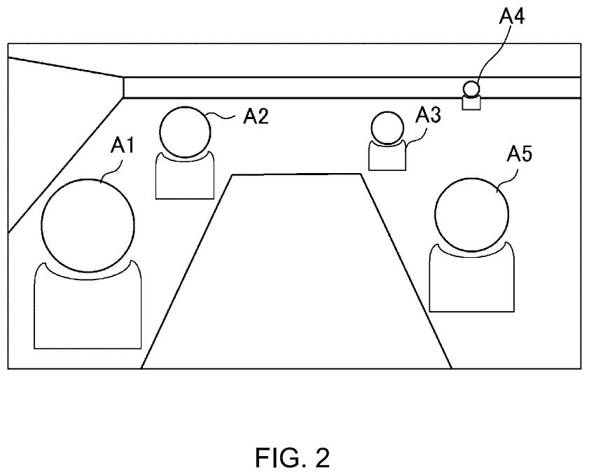

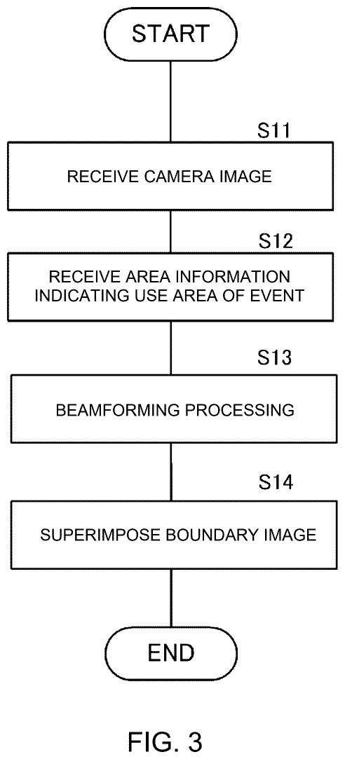

FIG. 2 is an example of a video displayed on the display unit 5 as an OSD (on-screen display) according to the display method of the present embodiment. FIG. 3 is a flowchart showing an operation of the display method according to the present embodiment.

The processor 12 first receives a camera image from the camera 11 (S11). In the example shown in FIG. 2, the camera 11 is capturing facial images of a plurality of persons positioned along the longitudinal direction (depth direction) of a desk. The camera 11 is imaging four persons, persons A1 to A3 and A5 on the left and right sides across the transverse direction of the desk, and a person A4 at a position farther than the desk.

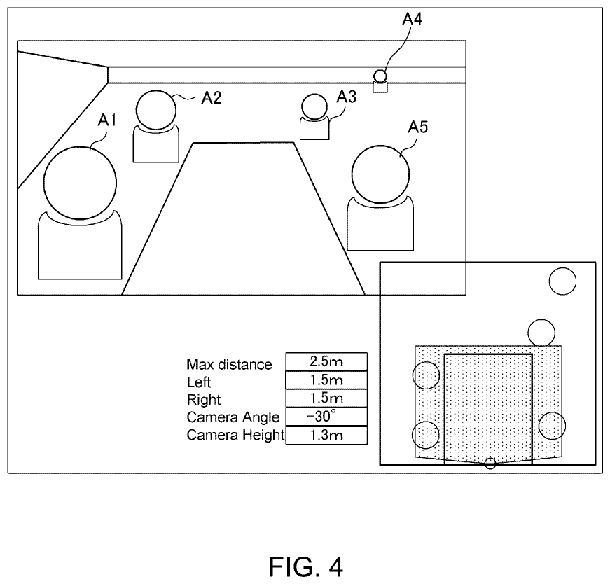

Next, the processor 12 receives area information indicating the use area of the event (S12). FIG. 4 is a diagram showing an example of a GUI (Graphical User Interface) displayed on the display unit 5. The processor 12 displays a GUI on the display unit 5 as an OSD, such as that shown in FIG. 4. In the example of FIG. 4, the processor 12 displays an interface for receiving the use area below the camera image, and displays a two-dimensional planar image simulating the interior of the room at the lower right position. The processor 12 also displays planar images of the desk and the persons.

The processor 12 receives the use area of the event via the user I/F 16. The user I/F 16 includes a user operable interface such as a mouse, a keyboard, or a touch panel superimposed on the display unit 5. In the example of FIG. 4, the user specifies the depth (max distance), the left-direction width (left), and the right-direction width (right) using numerical values to input the use area of the event. In addition, the user can use the user I/F 16 to draw and specify a prescribed planar figure on the two-dimensional planar image shown in FIG. 4 to input the use area of the event.

The processor 12 executes beamforming processing so as not to collect sounds outside of the use area based on the area information that has been received (S13). As a results, the processor 12 outputs, to the PC 3, sound signals relating to sounds collected in the specified use area.

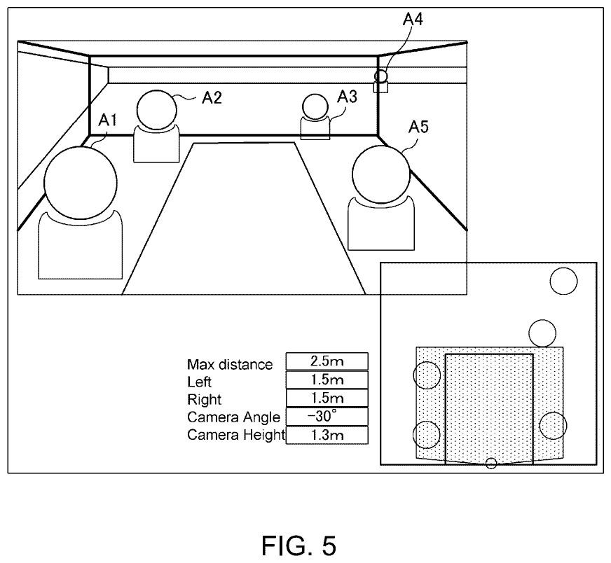

The processor 12 superimposes, on the camera image, a boundary image on a certain horizontal plane corresponding to the area information that has been received (S14). FIG. 5 is an example of a video displayed on the display unit 5 as an OSD according to the display method of the present embodiment. In the example of FIG. 5, the processor 12 displays boundary lines indicating the boundaries between the use area, and the floor surface and the ceiling surface.

The horizontal plane is determined based on the height (camera height) and elevation angle (camera angle) of the camera 11. In the examples of FIGS. 4 and 5, an interface for receiving the use area is displayed below the camera image. The user inputs numerical values of the height and elevation angle of the camera 11 via the user I/F 16. Alternatively, the camera 11 can automatically detect the height and elevation angle of the camera 11 using a rangefinder sensor such as LiDAR (Light Detection and Ranging) and an angle sensor such as a gyro sensor.

The processor 12 determines the vanishing point of the camera image based on the elevation angle of the camera 11 that has been received. For example, in the case when the elevation angle is 0°, the vanishing point is determined to be in the center of the camera image. When the elevation angle decreases, i.e., moves in the (negative) direction, the vanishing point in the camera image moves downward, and when the elevation angle increases, i.e., moves in the (positive) direction, the vanishing point in the camera image moves upward. Straight lines drawn radially from said vanishing point become straight lines that are parallel to a horizontal plane within real space, such as the floor surface or the ceiling surface. The processor 12 selects straight lines corresponding to the heights of the floor surface and the ceiling surface in accordance with the received height of the camera and displays the straight lines as an image of boundaries indicating the use area.

In addition, the processor 12 displays a boundary image in the depth direction of the use area as a rectangle, based on the right-direction width, the left-direction width, and the distance that have been received. As a result, the boundary image is constructed representing faces of a virtual rectangular box corresponding to the use area. The boundary image is indicated in bold in FIG. 5.

As a result, even when a use area and an unused area of a conference coexist in the same space, such as an open space, the user can look at the video displayed on the display unit 5 as an OSD to easily determine whether the user is in the use area (in this case, within the sound collection range of the microphones). In particular, in the case that an administrator such as a conference organizer sets the use range, it is possible to provide a novel customer experience in which a user other than the administrator can easily determine the use area.

In the example of FIG. 5, the processor 12 recognizes persons from the camera image and, among the recognized persons, displays persons who are in the use area and who are not in the use area in different ways. In the example of FIG. 5, persons A1, A2, and A5 are in the use area and persons A3 and A4 are not in the use area. Accordingly, the processor 12 displays the straight lines of the boundary image so as not to overlap persons A1, A2, and A5 and displays the straight lines of the boundary image so as to overlap persons A3 and A4. As a result, a user can look at the video displayed on the display unit 5 to more easily determine whether the user is in the use area (in this case, within the sound collection range of the microphones).

In this case, the processor 12 first determines whether persons are included in the camera image. The processor 12 carries out an image segmentation process, for example, to identify a plurality of pixels that represent one person. An image segmentation process is a process for recognizing the boundary between a person and the background by using a prescribed algorithm that uses a neural network, for example. For example, in the example of FIG. 5, the processor 12 recognizes five persons A1-A5. The processor 12 determines the distance to each person based on the size of the image of the recognized person. The flash memory 14 stores, in advance, a table, a function, or the like, that indicates the relationship between the distance and the size of an image of a person. The processor 12 compares the size of the image of the recognized person and the table stored in the flash memory 14 to determine the distance to the person.

In addition, the method of estimating the distance is not limited to the example described above. For example, if the camera 11 is a stereo camera (provided with two or more cameras), the processor 12 can determine the distance to each person based on the distance between the two cameras and the parallax between two images. The processor 12 can also determine the distance to each person using a rangefinder sensor, such as LiDAR (Light Detection and Ranging).

When the determined distance is within the use area, the processor 12 displays the straight lines of the boundary image so as not to overlap said person. When the determined distance is outside of the use area, the processor 12 displays the straight lines of the boundary image so as to overlap said person.

### First Modified Example 1

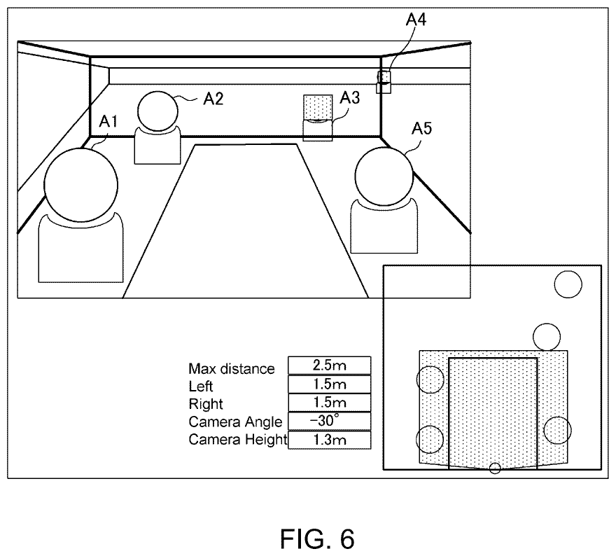

FIG. 6 is an example of a video displayed on the display unit 5 according to a First Modified Example. In the First Modified Example, the processor 12 can apply a mask process on images of persons not in the use area, as shown in FIG. 6. The mask process includes processes such as blurring, filling, or replacing with another image.

As a result, the processor 12 can prevent outputting images of persons other than conference participants, and can output natural-looking images while maintaining the privacy of non-participants.

### Second Modified Example

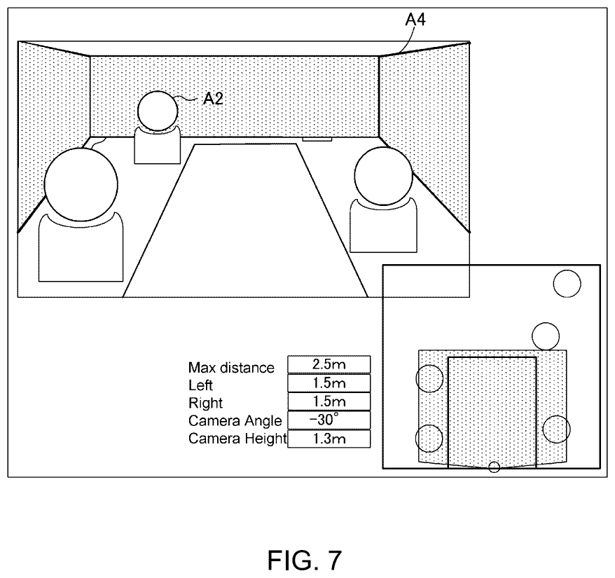

FIG. 7 is an example of a video displayed on the display unit 5 according to a Second Modified Example. In the Second Modified Example, the processor 12 masks the portions of the camera image outside of the use area, as shown in FIG. 7. The mask process includes processes such as blurring, filling, or replacing with another image. The processor 12 carries out a process of filling faces of the virtual rectangular box corresponding to the use area, as shown in FIG. 7.

As a result, a user can easily recognize the faces of the virtual rectangular box corresponding to the use area, and thus more easily determine whether the user is in the use area (in this case, within the sound collection range of the microphones). In addition, users can have the perception of carrying out a conference inside a virtual room. Furthermore, the processor 12 can prevent outputting images of persons other than conference participants, and can output natural-looking images while maintaining the privacy of non-participants.

### Third Modified Example

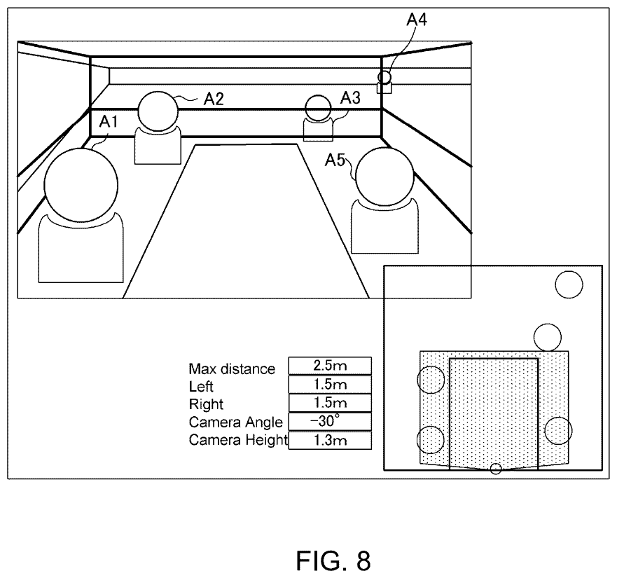

FIG. 8 is an example of a video displayed on the display unit 5 according to a Third Modified Example. In the Third Modified Example, the processor 12 displays straight lines corresponding to the height of the face, in addition to the heights of the floor surface and the ceiling surface, as the boundary image indicating the use area. In general, the height of one's face is about 0.6 to 1.8 m. The height of a face can be received from a user via the user I/F 16, or can be predetermined to be about 1.2 m, for example.

As a result, a user can look at a video displayed on the display unit 5 to more easily determine whether the user is in the use area (in this case, within the sound collection range of the microphones).

### Fourth Modified Example

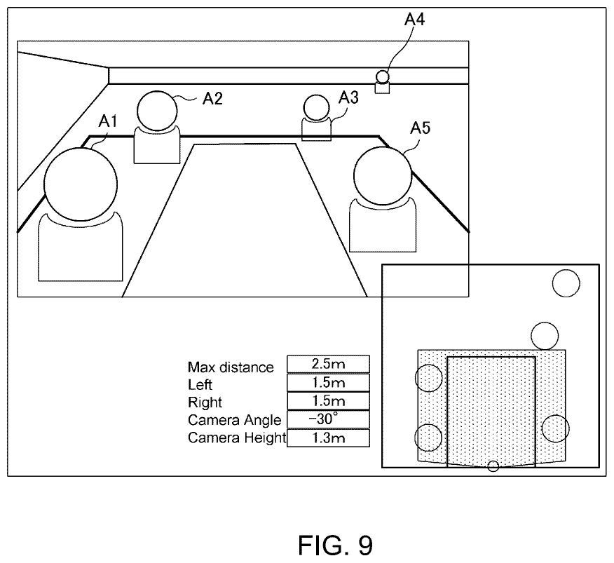

FIG. 9 is an example of a video displayed on the display unit 5 according to a Fourth Modified Example. In the Fourth Modified Example, the processor 12 displays only straight lines corresponding to the floor surface as the boundary image indicating the use area. In this manner, by simply displaying the boundary image on with the floor surface as a horizontal plane, a user can look at a video displayed on the display unit 5 to easily determine whether the user is in the use area (in this case, within the sound collection range of the microphones).

### Fifth Modified Example

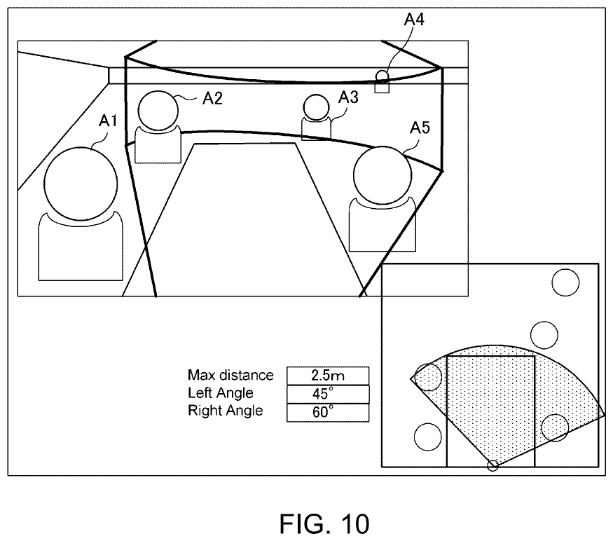

FIG. 10 is an example of a video displayed on the display unit 5 according to a Fifth Modified Example. In the embodiment described above, the use area has a rectangular shape in plan view, but the use area of the Fifth Modified Example is fan-shaped in plan view.

In the example of FIG. 10, a user specifies the depth (max distance), the left-direction angle (left angle), and the right-direction angle (right angle) to input the use area of the event. Alternatively, a user can use the user I/F 16 to draw and specify a prescribed planar figure on the two-dimensional planar image shown in FIG. 10 to input the use area of the event.

In the Fifth Modified Example, the processor 12 superimposes, on the camera image, the boundary image indicating the use area, and the floor surface and the ceiling surface. The processor 12 displays a boundary image in the depth direction of the use area using curved lines and boundary images in the left-right direction using straight lines, based on the right-direction angle, the left-direction angle, and the distance that have been received. As a result, a boundary image having a virtual columnar shape corresponding to the use area is constructed, as shown in FIG. 10.

In this case as well, a user can look at a video displayed on the display unit 5 to easily determine whether the user is in the use area (in this case, within the sound collection range of the microphones).

The description of the present embodiment is exemplary in all respects and should not be considered restrictive. The scope of the present invention is indicated by the Claims section, not the embodiment described above. Furthermore, the scope of the present invention includes the scope that is equivalent that of the Claims.

For example, the beamforming processing is not essential in this disclosure. The use area is not limited to the sound collection range of microphones. Areas in which images are masked are also examples of use areas, as shown in FIGS. 6 and 7. Furthermore, an event is not limited to a conference. Events also include games or ensembles performed between remote locations. In addition, events include home theaters. Home theaters may output a highly directional sound beam. In this case, the use area corresponds to the reach of said sound beam.

### Effects of this Disclosure

According to one embodiment of this disclosure, the range of use of an event can be easily understood.

What is claimed is:

1. A display method comprising:
receiving a camera image;
receiving area information indicating a use area of an event; and
superimposing, on the camera image, a boundary image on a horizontal plane and displaying the boundary image superposed on the camera image, the boundary image corresponding to the area information.

2. The display method according to claim 1, wherein
the horizontal plane includes a floor surface.

3. The display method according to claim 1, wherein
the use area corresponds to a sound collection range of a microphone.

4. The display method according to claim 1, further comprising
recognizing persons from the camera image, and
displaying, among the persons, a person in the use area and a person not in the use area in different ways.

5. The display method according to claim 1, further comprising
masking an area of the camera image outside of the use area.

6. The display method according to claim 1, further comprising
specifying the use area by a prescribed planar figure.

7. The display method according to claim 6, wherein
the use area is specified by specifying a depth, angle, or width of the prescribed planar figure.

8. The display method according to claim 1, wherein
the horizontal plane is represented by a boundary line that indicates a floor surface, a ceiling surface, or a plane at a height of a face.

9. A display processing device comprising:
a processor configured to
receive a camera image,
receive area information indicating a use area of an event, and
superimpose, on the camera image, a boundary image on a horizontal plane and display the boundary image superposed on the camera image, the boundary image corresponding to the area information.

10. The display processing device according to claim 9, wherein
the horizontal plane includes a floor surface.

11. The display processing device according to claim 9, wherein
the use area corresponds to a sound collection range of a microphone.

12. The display processing device according to claim 9, wherein
the processor is further configured to
recognize persons from the camera image, and
display, among the persons, a person in the use area and a person not in the use area in different ways.

13. The display processing device according to claim 9, wherein
the processor is further configured to mask an area of the camera image outside of the use area.

14. The display processing device according to claim 9, wherein
the processor is further configured to specify the use area by a prescribed planar figure.

15. A non-transitory computer-readable storage medium storing a program executable by a processor of a display processing device to perform a display processing method, the display processing method comprising:
receiving a camera image;
receiving area information indicating a use area of an event; and
superimposing, on the camera image, a boundary image on a horizontal plane and displaying the boundary image superposed on the camera image, the boundary image corresponding to the area information.
